(19) United States
(12) Patent Application Publication
(10) Pub. No.: US 2023/0368457 A1
(43) Pub. Date: Nov. 16, 2023

(54) METHOD AND SYSTEM FOR THREE-DIMENSIONAL SCANNING OF ARBITRARY SCENES

(71) Applicant: Northwestern University, Evanston, IL (US)

(72) Inventors: FLORIAN WILLOMITZER, Evanston, IL (US); Oliver Strider Cossairt, Evanston, IL (US)

(21) Appl. No.: 18/144,632

(22) Filed: May 8, 2023

Related U.S. Application Data
(60) Provisional application No. 63/340,670, filed on May 11, 2022.

(51) Int. Cl. G06T 15/06; G06V 10/141; G06V 10/60; G06V 10/74

(52) U.S. Cl. CPC G06T 15/06; G06V 10/141; G06V 10/60; G06V 10/761

(57) ABSTRACT

A three-dimensional (3D) imaging system includes a projector configured to illuminate a scene. The 3D imaging system also includes a first camera configured to capture first data from the scene during illumination by the projector and a second camera configured to capture second data from the scene during the illumination by the projector. The 3D imaging system further includes a processor in communication with the first camera and the second camera. The processor is configured to process the first data and the second data to generate a 3D image or a 3D video.

### CROSS-REFERENCE TO RELATED APPLICATION

The present application claims the priority benefit of U.S. Provisional Patent App. No. 63/340,670 filed on May 11, 2022, the entire disclosure of which is incorporated herein by reference.

### BACKGROUND

Three-dimensional (3D) imaging and processing techniques have been used in industry, medicine, forensics, and art for many years with great success. If captured successfully (i.e., artifact free and with high quality), 3D object representations contain a distinctive higher information content than simple two-dimensional (2D) images, and can be used in a variety of different applications. Three-dimensional imaging can potentially be used to address new challenges in the field of computer vision, such as object/person identification, automated defect detection, self-navigation of autonomous robots, drones, or cars under complicated (crowded) environmental conditions, etc. With recent advances in computing technology, users and researchers can choose from a huge selection of available 3D sensor concepts and software, some of which can even be implemented on mobile phones.

### SUMMARY

An illustrative three-dimensional (3D) imaging system includes a projector configured to illuminate a scene. The system also includes a first camera configured to capture first data from the scene during illumination by the projector. The system also includes a second camera configured to capture second data from the scene during the illumination by the projector. The system further includes a processor in communication with the first camera and the second camera, where the processor processes the first data and the second data to generate a 3D image or a 3D video.

In an illustrative embodiment, the projector is a laser dot scanner that is configured to scan the scene with a single laser dot. In another embodiment, the first camera is a first event camera and the second camera is a second event camera, and the processor is configured to identify a correspondence for each event-timestamp generated by the second event camera by comparing a position of the single laser dot on the scene with a pixel position of an event on the second event camera. In another embodiment, the processor is further configured to calculate surface normals of the scene by tracing rays from the position of the single laser dot back to a camera chip of the second event camera.

In another illustrative embodiment, the processor does not have prior information regarding a geometry or a reflectance of the scene. In another embodiment, the first camera captures a portion of an environment in which the scene is located, and the portion of the environment is used as a screen to perform deflectometry. In another embodiment, the processor uses the projector and the first camera to form a deflectometry sub-sensor. In another embodiment, the processor uses the projector and the second camera to form a triangulation sub-sensor.

In one embodiment, the processor is configured to separate specular components and diffuse components of the scene based on one or more of the first data and the second data. In such an embodiment, the processor is configured to use the diffuse components of the scene as a screen to perform deflectometry on the scene. In another embodiment, the first camera comprises a first event camera, and wherein the first event camera is configured to produce a timestamp of brightness changes at each pixel being imaged in the scene.

An illustrative method of three-dimensional (3D) imaging includes illuminating, by a projector, a scene that is to be imaged. The method also includes capturing, by a first camera, first data from the scene during illumination by the projector. The method also includes capturing, by a second camera, second data from the scene during the illumination by the projector. The method further includes processing, by a processor in communication with the first camera and the second camera, the first data and the second data to generate a 3D image or a 3D video.

In one embodiment, the projector comprises a laser dot scanner, and the illuminating comprises scanning the scene with a single laser dot. In another embodiment, the first camera comprises a first event camera and the second camera comprises a second event camera. In such an embodiment, the method includes identifying, by the processor, a correspondence for each event-timestamp generated by the second event camera by comparing a position of the single laser dot on the scene with a pixel position of an event on the second event camera. The method can also include calculating, by the processor, surface normals of the scene by tracing rays from the position of the single laser dot back to a camera chip of the second event camera.

In another embodiment, the method includes capturing, by the first camera, a portion of an environment in which the scene is located, and using the portion of the environment as a screen to perform deflectometry. The method can also include forming, by the processor, the projector and the first camera into a deflectometry sub-sensor. The method can also include forming, by the processor, the projector and the second camera into a triangulation sub-sensor. In one embodiment, the method includes separating, by the processor, specular components and diffuse components of the scene based on one or more of the first data and the second data. In another embodiment, the method includes using, by the processor, the diffuse components of the scene as a screen to perform deflectometry on the scene.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts active triangulation (structured light) for matte surfaces under moderate background illumination in accordance with an illustrative embodiment.

FIG. 1B depicts event-based triangulation (“MC3D”) for matte surfaces under extreme illumination conditions in accordance with an illustrative embodiment.

FIG. 1C depicts deflectometry for specular surfaces in accordance with an illustrative embodiment.

FIG. 2A depicts the limited angular coverage in a traditional deflectometry system in accordance with an illustrative embodiment.

FIG. 2B depicts a system for performing a triangulation measurement with two event cameras and a laser projector in accordance with an illustrative embodiment.

FIG. 2C depicts a system for performing a deflectometry measurement with two event cameras and a laser projector in accordance with an illustrative embodiment.

FIG. 3A depicts how a specular surface can reflect the laser beam back into a camera (unlikely, but undesired) of the system in accordance with an illustrative embodiment.

FIG. 3B depicts how the laser beam initially hits a specular surface and is reflected onto a diffuse surface in accordance with an illustrative embodiment.

FIG. 3C depicts the laser beam hit a diffuse surface part which is observed by the camera directly plus over one or more specular surfaces in accordance with an illustrative embodiment.

FIG. 4A depicts a cross-polarizer to reject direct specular reflections in accordance with an illustrative embodiment.

FIG. 4B depicts utilization of angular information (provided by the second camera) to reject incorrect 3D points in accordance with an illustrative embodiment.

FIG. 4C depicts utilization of angular information (provided by the second camera) and geometrical constraints to confirm correct 3D points in accordance with an illustrative embodiment.

FIG. 5 depicts a computing system for performing 3D imaging in accordance with an illustrative embodiment.

### DETAILED DESCRIPTION

State-of-the-art 3D imaging methods are not able to measure all possible classes of objects at once and still need to be tailored to a specific application. This is one of the main reasons why 3D imaging is not omnipresent in our society, and why only trained experts with task-specific equipment are able to capture high-quality 3D models. The reason that such tailoring is required is not due to technical restrictions but is rather caused by deep physical characteristics of the system. Light can interact with object surfaces in many complicated ways (e.g., diffuse scattering, volume scattering, specular reflection, etc.). Different forms of illumination (directed, structured, pulsed, etc.) and detection (point, focal plane array) can be applied, and additional light modalities (polarization, coherence, etc.) might be exploited. A simple combination and permutation of all possible options leads to about 8000 different possible 3D sensor principles, when using traditional techniques. Profound experience is therefore necessary to choose the best sensor configuration for each application.

The proposed system has the potential to change this. Specifically, the proposed system enables precise 3D measurements of complicated surfaces/scenes in today's billion-dollar industries, like VR/AR/MR, industrial inspection, autonomous navigation, and medical imaging. Many of these industries routinely run into particularly challenging scenarios for 3D scanning systems. Moreover, a scene-independent precise 3D sensing system accessible to a wide audience has an even broader impact in that the produced sets of high-quality 3D data can usher the next wave in vision-related artificial intelligence (AI), leading to algorithms with unprecedented detection quality, prediction accuracy, and navigation precision. Given the current dissimilation of AI-based techniques in all sectors of modern society, everyone can benefit from this system. The proposed system will also have an educational impact in training the next generation science, technology, engineering, and math (STEM) workforce since the system and techniques can be integrated into university course curriculums.

Described herein are methods and systems to facilitate computer vision applications at metrology-grade data precision. The proposed technology can be used by virtual reality (VR) users, mixed reality (MR) users, robots, etc. to precisely grasp small physical objects around them (like a pen, button, or coin). The proposed technology can also be used by surgical machines to make more accurate cuts than the best trained human (even on shiny and moving objects like an open heart). Similarly, small robots and drones can use this technology to effortlessly navigate through the most crowded and complicated environments (e.g., for repairing large machines from the inside). For the first time, described herein is a 3D imaging principle which is flexible, robust, and accurate enough to enable such applications.

The proposed approach presents a ‘one size fits all’ solution for arbitrary scenes with mixed reflectance properties. The solution is based on high-resolution 3D imaging principles, but facilitates novel sensor technology and sophisticated evaluation algorithms to measure complicated real-world scenes. The technique allows one to capture scenes with a broad structural variety of surface reflectance properties, surface frequency (smooth or detail-rich), and ambient illumination. In contrast, state-of-the-art methods can only be optimized towards a specific sub-space of this variety. Described herein is the development, construction, evaluation, and testing of the proposed 3D scanning system having significantly greater performance than state-of-the-art scanners.

The proposed system introduces a feasible solution to a long-standing problem in computer vision. Specifically, traditional high-resolution active 3D scanning results in scenes that are cluttered with objects of mixed specularity and polluted by undesirable light contributions such as ambient illumination or strong inter-reflections. Existing approaches to address this challenging task deliver rather sobering results or rely on large training datasets or other extensive prior knowledge, such as the geometry and reflectance of objects in the scene. An easy and flexible solution that delivers high-quality data is of significant interest for researchers in the broader vision community.

In one embodiment, the proposed system exploits the novel detection modality of biologically inspired event sensors (which operate on a fundamentally different principle than conventional sensors) and properly facilitates the existing tradeoffs in 3D imaging. In such an embodiment, the concept upon which the system is based capitalizes on the strengths of event sensing (low latency, high dynamic range) while simultaneously exploiting its actual weakness (low signal density) to solve the profound ambiguity problem caused by various signal interreflections. The proposed technique significantly advances the state-of-the-art and the fundamental understanding of limits. As used herein, an event sensor or event camera can be any type of device that is able to produce a timestamp of brightness changes at each pixel being imaged. More specifically, an event sensor (also referred to as a dynamic vision sensor or neuromorphic camera) stores a reference brightness level and continuously compares the stored reference brightness level to a current brightness level at each pixel. If the difference in brightness exceeds a threshold value, the pixel resets its reference brightness level and generates an event, which is a discrete packet that contains the pixel address and a timestamp. In alternative embodiments, the system can be implemented using standard sensors as opposed to event sensors.

In recent years, the computer vision community has made great strides towards 3D imaging and the rendering of real-world scenes, i.e., scenes containing objects with mixed surface reflectivity, reflectance characteristic, or scattering properties. In this field, acquisition and evaluation are often optimized towards the most realistic looking output with the goal to receive impressive photorealistic results. It is acceptable in many cases if raw 3D measurement results are purely qualitative or display only moderate depth precision (oftentimes >1 centimeter (cm)) that is later concealed by post-processing.

Research in the field of optical 3D metrology can be seen as counterpart to this application scenario and resides on the other end of the 3D imaging spectrum. Here, the primary goal is a quantitative measurement of the surface under test with a very good depth precision—in many cases down to micrometers (μm) or even nanometers (nm). In optical 3D metrology, a photo-realistic visualization of the results is not desired in many cases, and the measured data are barely post-processed. The extremely high precision requirements have led to the 3D metrology sensor complexity discussed above, i.e., a specifically tailored 3D sensor solution for each application and surface.

This proposed system is motivated by the notion of what would be possible if one combines the best of both worlds, i.e., facilitating computer vision applications at metrology-grade data precision. The solution is based on high-resolution 3D metrology concepts, and facilitates sophisticated evaluation algorithms and novel event-based sensor technology (in at least some embodiments) to measure complicated real-world scenes containing arbitrary objects with arbitrary reflectance and appearance properties. In stark contrast to existing computer vision solutions working at lower resolution, no prior information or assumptions about the scene (e.g., in form of geometry or reflectance) is required.

State-of-the-art quantitative 3D imaging principles can be broadly categorized into three groups: a) Triangulation-based principles (also referred to as “structured light”), including Passive Stereo, Fringe Projection, Dot Pattern Projection (as used, e.g., in Apple FaceID), or Laser Line Scanning, b) Time-of-Flight-based principles, including so-called Time-of-Flight cameras, Interferometry, and Holography, and c) Reflectance-based principles including Deflectometry and Photometric Stereo. Although this distinct differentiation of principles is more inherent to metrology, all described methods have been used as well in the computer vision community for years, where they are commonly grouped in a much broader context and referred to as, e.g., “Shape from . . . ”. The proposed system does not further consider ToF-based principles, since they either provide only depth precisions in the cm-range (which is far below the targeted precision of the proposed system), or do not work under diffuse scattering conditions. The proposed system also does not consider passive methods, since they generally provide lower depth precision and do not work under arbitrary illumination conditions (e.g., in the dark).

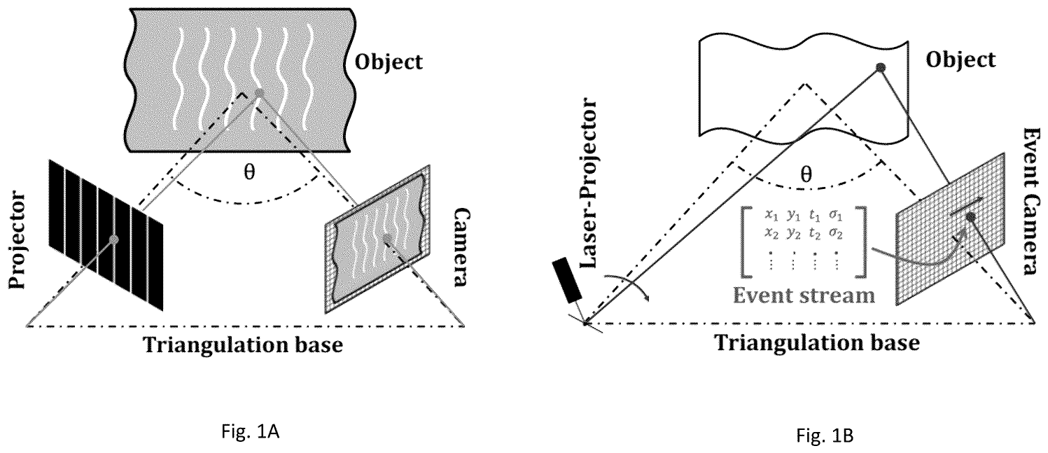

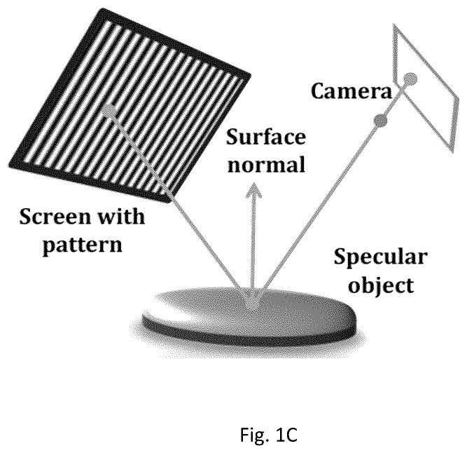

FIG. 1A depicts a process for active triangulation (structured light) under moderate background illumination in accordance with an illustrative embodiment. FIG. 1B depicts event-based triangulation (“MC3D”) under extreme illumination conditions in accordance with an illustrative embodiment. FIG. 1C depicts deflectometry for specular surfaces in accordance with an illustrative embodiment. The proposed concept combines the unique benefits of these methods to measure complicated real-world scenes.

Active Triangulation (“Structured Light”) is described below. In its most basic form, Active Triangulation relies on a light source that projects a known pattern (e.g., laser dot, laser line, pattern from pattern projector, etc.) onto an object surface, and a camera that observes the object surface under a “triangulation angle” θ(see FIG. 1A). For θ>0° the pattern, recorded from the viewpoint of the camera is deformed/displaced in the camera image and the three-dimensional structure of the scene can be calculated from this deformation/displacement. The optimal triangulation sensor should combine three basic characteristics. First, the optimal triangulation sensor should be “single-shot”, which makes the sensor robust to (rigid and non-rigid) object motion. Second, the sensor should provide a high depth precision. Lastly, an optimal triangulation sensor should sample the surface at a high density of independently measured (uncorrelated) 3D points. The last two characteristics are essential to capture high frequencies of the surface, which can include small surface features like wrinkles, imprints, granularity, etc. The inventors have shown that the three named characteristics form an uncertainty relation, meaning that nature prohibits a 3D sensor that provides all three characteristics at the same time.

Based on this derived uncertainty relation, the inventors developed and built a triangulation sensor that works at the fundamental limits of physics and information theory. A prototype of a Single-Shot 3D Movie Camera was developed, and it delivers 300,000 independent 3D points with high depth precision (<200 μm on human skin) from each 1 Megapixel (Mpix) camera frame. A 3D sensor with these features allows for a continuous 3D measurement of fast-moving or deforming objects, resulting in a continuous 3D movie. Like a hologram, each movie-frame encompasses the full 3D information about the object surface, and the observation perspective can be varied while watching the 3D movie.

As discussed above, event-Based Structured Light (“MC3D”) is another triangulation technique used in the proposed system. As a response to the fundamental tradeoff discussed above in MC3D systems, the inventors proposed a workaround. The basic idea is to perform a raster-scan of an object with a very sparse pattern (e.g., a laser dot) for many subsequent samples, where the scanning is conducted at an incredibly high speed. As a result, the effective time to capture a full-field 3D model is no longer than the exposure time of a normal camera operating at 30 frames per second (fps) or 60 fps. Approaching the problem from this direction only becomes feasible by applying novel camera technology that works very different from conventional frame-based cameras. Instead of delivering a synchronously captured frame of pixel values, the pixels of an “Event Camera” or “Motion Contrast Camera” independently and asynchronously generate output when they observe a temporal intensity gradient. The motion contrast output stream appears as a sparse distribution of discrete events corresponding to individual pixel changes. The n^{th} event in the stream is a vector of the form Eₙ=(xₙ, yₙ, tₙ, σₙ) where x and y stand for the pixel coordinate, t for the timestamp, and σ for the “polarity” of the event (positive or negative intensity gradient). The sparse event-stream allows the camera to operate at extremely low latency (down to microseconds (μs)), compared to full-frame conventional cameras. To avoid expensive laser-scanning hardware, the inventors use an off-the shelf laser pico-projector, whose image formation already relies on rapidly scanning a laser dot over the field of view. Besides the low latency, event cameras have another property which becomes beneficial for the purpose of the proposed system. Namely, event cameras have an extremely high dynamic range (˜140 decibels (dB) instead of 60 dB), which is partially caused by the fact that the system rejects constant ambient light since it measures the temporal gradient (as shown in FIG. 1B).

In one embodiment, the proposed system can be in the form of a 3D scanning system that exploits the beneficial properties of event cameras. However, purely triangulation-based approaches cannot be used to implement the system since they do not work on specular and shiny surfaces. The reason for this is straightforward. After a specular surface reflection the light rays scarcely find their way back into the aperture of the camera, since all rays originate from one single point (i.e., the nodal point of the projector). It is noted that this is also true for time-of-flight-based methods. The inventors therefore turned to another 3D paradigm, deflectometry.

A straightforward solution to the problem described above is to extend the angular support of the illumination source. This is the basic principle behind deflectometry, where a screen that displays a known pattern replaces the ‘point-like’ light source (see FIG. 1C). This screen can be self-illuminated (e.g., television monitor or display) or printed. In deflectometry systems, the screen and camera face the object, which means that the camera observes the specular reflection of the screen over the object surface. Again, the observed pattern in the camera image is a deformed version of the image on the screen, where the deformation depends on the surface normal distribution of the object surface. From this deformation, the normal vectors of the surface can be calculated. Numerical integration of the obtained surface normal map eventually delivers the 3D shape of the measured surface. Deflectometry is a well-known principle in optical 3D metrology that can reach a precision close to interferometric methods down to several nanometers.

One of the key aspects of the proposed system is the notion of having a single camera sensor that can detect visual scenes (e.g., similar to a video imager), but that can be adapted into any type of imager system that provides the most useful information for a given scene/object to be captured. In particular, this means that a 2D imager can seamlessly switch between different resolutions and framerates, and would rely on machine learning to autonomously be aware of what is happening in the field of view and to reconfigure the imaging sensor based on the context of the scene/object to be captured.

The inventors' vision was to develop a system with the same capabilities for 3D sensing. The preceding discussion has shown that the notion of framerate, resolution, and imaging modalities also exist for 3D models. For example, the “effective 3D framerate” is in many cases lower (or much lower) than the framerate of the used camera. Also, the “3D resolution”(3D feature resolution and depth resolution) is rarely as good as the resolution of the camera chip or the used optics. The reasons for this lie in deep physical and information theoretical limitations of 3D imaging.

Conversely, the proposed 3D sensor will be able to scan a truly broad range of different scenarios. Examples are scenes that include specular, shiny, and diffuse objects, or participating media (fog, water), possibly under very challenging signal-to-noise or signal-to-background conditions (sunlight). Leveraging the huge potential of deep learning, the final system is able to automatically detect regions of high interest and scan them at high spatial and temporal resolution. In order to do this in 3D, it is also imperative to use new optimization-based pattern encoding strategies. This means that the system is able to dynamically adjust the projected/displayed light patterns to the scene. Current approaches consider only the shape of the scene to optimize the pattern. The proposed system can also utilize an optimization procedure that considers reflectance properties, volumetric scattering conditions, and/or background illumination to develop a holistic 3D sensor system with unprecedented capabilities.

The proposed system enables the vision of computer vision applications at metrology-grade data precision. As discussed, this is of significant interest for a number of high-impact applications in billion-dollar industries (e.g., industrial inspection, autonomous navigation, medical imaging, and VR/AR/MR), which routinely run into particularly challenging vision scenarios. The proposed system will help overcome the limitations of current approaches and increase the partnership between industry and academia. As there are plans for wide open-source availability, the proposed method has an even broader impact. Specifically, the produced sets of high-quality 3D data can usher the next wave in vision-related AI, leading to algorithms with unprecedented detection quality, prediction accuracy, and/or navigation precision. Given the current dissimilation of AI-based techniques in all sectors of modern society, everyone can benefit.

As the discussion above has shown, the current state-of-the-art lacks a quantitative one size fits all 3D sensor concept solution. The proposed system aims to provide this solution to the above-discussed problems in traditional 3D imaging techniques. To implement the system, the inventors have developed a sensor which will enable event-based measurements of purely specular surfaces in the wild (i.e., without known and properly defined screens). The event-based measurements of specular surfaces in the wild can be dubbed “Event Deflectometry”.

To concisely explain the basic idea behind Event-Deflectometry, one can motivate it as extension of a Motion Contrast Camera concept “MC3D”, towards specular surfaces. In its simplest form (only used here for illustration) the laser projector raster scans an area on a screen or a wall, which is used instead of a display. This area is observed over the surface of the specular object of interest. Eventually, the surface shape is evaluated by implementing the novel notion of event streams into the Deflectometry algorithm. First, a correspondence is found for each event-timestamp by evaluating (or calibrating) the position of the laser dot on the screen and comparing it with the pixel position of the event on the camera chip. Eventually, the surface normals are calculated by tracing rays from the laser dot position on the calibrated screen to the surface and back to the camera chip (see also FIG. 1C).

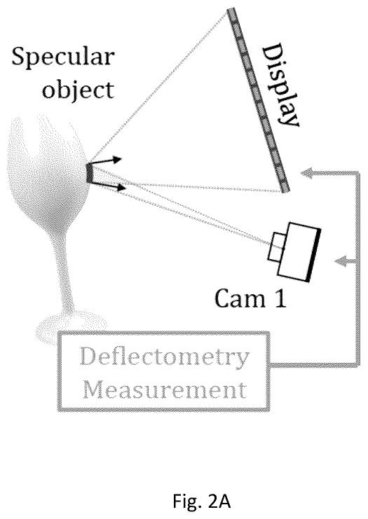

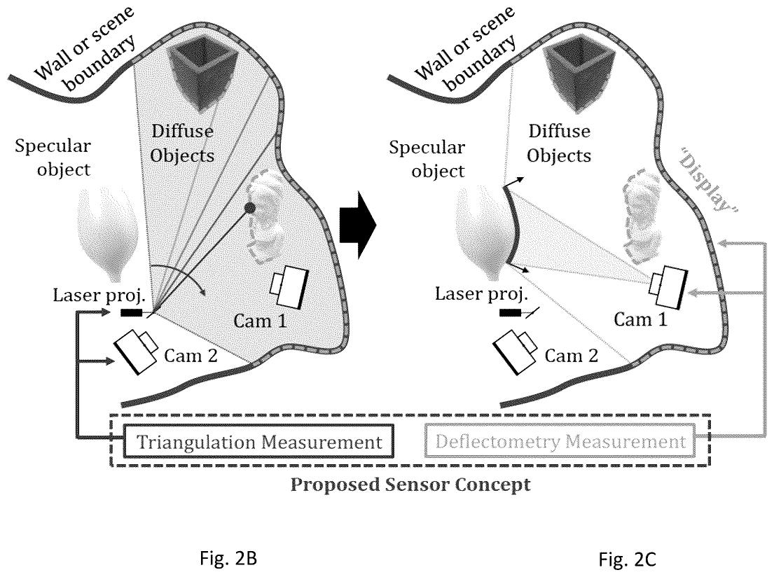

However, although the procedure described above is fast and efficient (compared to standard phase measuring deflectometry), it does not solve one of the most important problems in standard deflectometry, which is limited angular coverage. FIG. 2A depicts the limited angular coverage in a traditional deflectometry system in accordance with an illustrative embodiment. Specifically, due to the limited spatial extend of the screen only a very limited angular range of surface normals can be measured with the camera, which in turn leads to a limited coverage of measured surface area. It should be noted, however, that this is also dependent on the shape of the measured surface. Increasing the screen size helps to increase the angular coverage, but this cannot be done indefinitely.

For this reason, the inventors have moved away from a predefined screen with predefined and calibrated size and shape, and instead utilize the environment of the specular object as a screen. This is highly beneficial, since the environment of the specular object can provide much larger angular coverage (see FIG. 2C). Possible examples for proper screens are upper room corners (two walls plus ceiling), or even entire rooms themselves including all diffuse objects located in the room. For outdoor settings, the screens could be walls, trees, hedgerows, parked cars, etc. FIG. 2B depicts a system for performing a triangulation measurement with two event cameras and a laser projector in accordance with an illustrative embodiment. FIG. 2C depicts a system for performing a deflectometry measurement with two event cameras and a laser projector in accordance with an illustrative embodiment. In the depicted embodiments, the second event camera (Cam 2) and the laser projector form a triangulation sub-sensor to evaluate the shape and position of the environment (including all surrounding diffuse objects). The first event camera (Cam 1) and the environment (structured by the laser projector) form a deflectometry sub-sensor to evaluate a normal map of the specular object of interest. In alternative embodiments, any type of regular (i.e., non-event) cameras may be used instead of event cameras to implement the system.

As noted, the proposed sensor concept utilizes two event (or regular) cameras and one laser dot projector (e.g., a pico projector). To form a screen with an angular coverage as large as possible, the laser projector scans the environment, which is observed by one event camera (Cam 2 in FIG. 2B) that is optionally equipped with a wide-angle objective lens. The other camera (Cam 1) faces the specular object of interest and observes a laser dot projected on the background over the specular surface. As discussed, the proposed concept involves Cam 2 and the laser projector forming a Triangulation sub-sensor to evaluate the shape and position of the environment (including all diffuse objects). Cam 1 and the environment (structured by the laser dot) form a deflectometry sub-sensor to evaluate the normal map of the specular object of interest, as shown in FIG. 2C.

A crucial part in standard deflectometry is the geometric calibration of screen coordinates. Commonly, a planar screen model with regularly spaced pixels is assumed, and the pose of the screen in space is evaluated during an additional step of the geometric calibration. In the proposed sensor concept, one can simply replace this screen model with the 3D model of the environment that is evaluated by the triangulation sensor (Cam2+laser projector). Although the shape and pose of this new “screen/display” is arbitrary for each measurement, it is known and hence can be fed into the deflectometry evaluation algorithm.

It is noted that the measurement of both sub-sensors happens simultaneously. Moreover, all evaluation steps together are computationally inexpensive, which means that the whole sensor concept can easily be implemented in a real-time and motion-robust fashion. This will facilitate the 3D measurement of very complicated moving scenes where object, sensor, and even background (e.g., walking persons) are all allowed to move at the same time (events from a moving scene and the laser can be separated using known methods). Even non-rigid movements (water surfaces, moving curtains, etc.) can be handled.

It is also noted that the proposed system is not limited to the use of event cameras and that standard cameras can alternatively be used. Nevertheless, event cameras have distinctive advantages which are centered around their two main benefits: high dynamic range and low latency. The high dynamic range allows the system to exploit a variety of different diffuse surfaces with varying albedo as a “screen”. It ensures that light return can still be measured, regardless of whether the background is composed of a black cloth and/or a white wall that is illuminated by sunlight. Moreover, it allows for background objects with surfaces that might be not purely diffuse, since some light of the (weak) diffuse reflection can still reach the camera. High dynamic range (HDR) cameras with logarithmic sensitivity can reach similar performance, but lack a built-in differentiator to suppress background illumination.

The low latency allows the system to raster-scan the scene with a single laser dot, while still achieving motion-robust measurements at an effective 3D framerate of 30 frames per second (fps) to 60 fps. Established 3D imaging principles avoid raster scanning by projecting/displaying an extended structured pattern, such as sinusoidal fringes or binary (possibly coded) line structures. Although successfully used in standard 3D imaging, such extended patterns bring up two serious problems for the proposed approach: i) an unknown Bidirectional Reflectance Distribution Function (BRDF) of the background scene (i.e., screen), and ii) the ambiguity problem.

Utilizing non-binary patterns like sinusoids requires a radiometric “screen” calibration, meaning that the BRDF from all object surfaces in the background needs to be known or elaborately measured. This is unfeasible and not in the spirit of the proposed idea. With respect to ambiguity, extended patterns like sinusoids or multi-lines introduce ambiguities because they make it difficult to determine which line is which in the camera image. Such ambiguities are commonly resolved by acquiring a temporal sequence of different patterns (not motion-robust) or by looking at the spatial neighborhood of each pixel, which introduces an inherent low pass filter (no high object frequencies measurable). Both of these resolutions are not in the spirit of the proposed system. The ambiguity problem becomes even worse (and potentially unsolvable in some cases) if the scene contains specular and diffuse objects at the same time.

Described below is a new method to separate diffuse and specular objects in mixed scenes and to solve the profound ambiguity problem. As before, the method combines laser raster-scanning with event (or regular) cameras by exploiting their distinctive advantages, while meaningfully utilizing their weakness at the same time. The concept proposed above assumes that the laser projector solely illuminates the non-specular parts of the scene to be used as a screen directly, and that the specular object under test is only indirectly illuminated by the screen. This assumption might not be feasible for arbitrary scenes in practice. Backgrounds like rooms or outer walls might contain windows, metallic surface parts might be present, etc. For this reason, the system generalizes the principle to arbitrary mixed scenes without any previous knowledge of which parts of the scene are reflective or diffuse. In the spirit of this generalization, both cameras are now observing the entire mixed scene, which is structured by the laser projector. There is no notion of a triangulation-camera or a deflectometry-camera anymore, since both cameras are observing both classes of objects simultaneously. Allowing additional specular objects in the background that potentially need to be measured as well introduces additional problems, which are most disturbing when happening in the epipolar plane spanned by the camera and projector.

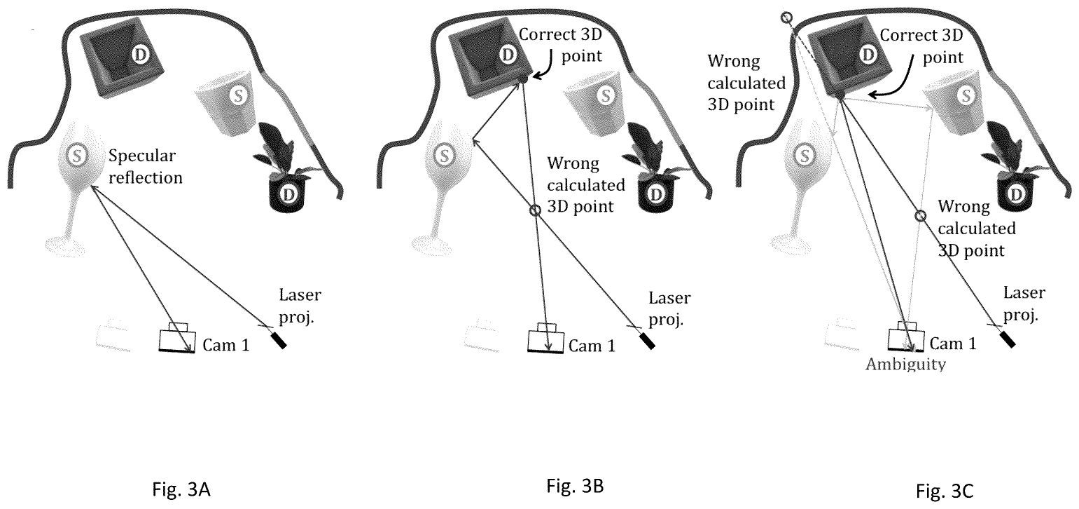

The above-discussed problems can be categorized into three groups which are depicted in FIGS. 3A-3C. FIG. 3A depicts how a specular surface can reflect the laser beam back into a camera (unlikely, but undesired) of the system in accordance with an illustrative embodiment. FIG. 3B depicts how the laser beam initially hits a specular surface and is reflected onto a diffuse surface in accordance with an illustrative embodiment. In a calibrated triangulation system, the position of a 3D point in space is always assumed at the intersection of the illumination ray and the camera ray. Hence, the above constellation can lead to an incorrect 3D point. FIG. 3C depicts the laser beam hit a diffuse surface part which is observed by the camera directly plus over one or more specular surfaces in accordance with an illustrative embodiment. As shown, this introduces ambiguities which can lead to incorrect 3D points. In FIGS. 3A-3C, the drawing plane is the epipolar plane, the ‘S’ represents specular objects, and the ‘D’ represents diffuse objects.

The presence of diffuse and specular object surfaces in the scene makes it imperative to separate diffuse and specular surface parts from one another such that the system can distinguish diffuse reflections from specular reflections. Otherwise, the processing pipeline outlined above cannot be executed. Described below is an algorithmic solution to filter out the diffuse components of the scene. These diffuse scene components eventually act as a deflectometry screen/display in the succeeding evaluation step for the specular surfaces. The order of the described solution operations mirrors the above problem categorization (i.e., a) direct specular back-reflection, b) incorrect 3D point caused by specular reflection, and c) 3D point ambiguities). Besides the simple hardware solution to problem a), all solutions are based on exploiting a distinct modality. Specifically, additional angular information is introduced by the multi-view geometry using a second camera.

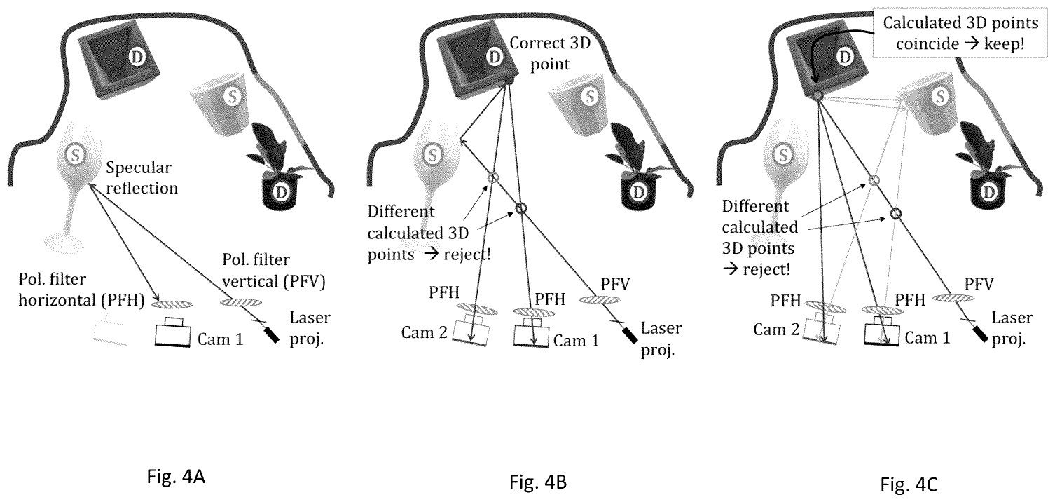

The solution approach involves calibrating the two cameras and the projector together such that the system can be again decomposed in two sub-sensors (Cam1+Projector and Cam2+Projector). By operating both sub-sensors in triangulation-mode, one can use geometrical constraints to filter out the diffuse surface parts and to reject the specular surface parts until they are separately evaluated in the next evaluation operation. The proposed procedure to each problem category a)-c) is depicted in FIGS. 4A-4C. Specifically, FIG. 4A depicts a cross-polarizer to reject direct specular reflections in accordance with an illustrative embodiment. FIG. 4B depicts utilization of angular information (provided by the second camera) to reject incorrect 3D points in accordance with an illustrative embodiment. FIG. 4C depicts utilization of angular information (provided by the second camera) and geometrical constraints to confirm correct 3D points in accordance with an illustrative embodiment.

In FIG. 4A, a hardware solution is utilized to reject direct specular reflections. The hardware solution includes crossed polarizers. Since polarization is preserved when undergoing a specular reflection, direct specular reflections can be filtered out by mounting the crossed polarizers on the projector and camera(s). As depicted in FIG. 3B, an incorrect 3D point is calculated at the intersection between a projector ray and a camera ray. The same is true for the Cam 2 sub-system. However, due to the different perspective, the two 3D points calculated in space do not coincide because they are not located at the same 3D coordinate in space. Hence, these points can be labeled as wrong and rejected. This procedure is shown in FIG. 4B. As depicted in FIG. 3C, a diffuse reflection observed over one or many specular surfaces produces ambiguities which leads to the evaluation of several 3D points that could be correct or incorrect. The same happens for Cam 2. However, only the single correct surface point coincides in the evaluated point clouds from both cameras. The rest can be rejected. FIG. 4C depicts the procedure for the correct point and one ambiguity (the 2^{nd} ambiguity of FIG. 3C has been omitted for the purpose of clarity).

It is noted that the above explanations and drawings in FIGS. 3 and 4 are intentionally reduced to 2D and focus only on very few specular reflections or ambiguities for the purpose of a clear and concise explanation. However, it has been shown that the approach is indeed generalizable to very complicated 3D scenes containing many diffuse and specular objects. This is due in part to the advantage of having only one single laser ray for illumination (instead of, e.g., a line pattern). The use of a single laser ray for illumination is widely considered as the weakness of event cameras, in that the sensor can only handle sparse signals if the low latency is to be maintained (i.e., no fringes, cross patterns, etc.). This has ultimately made the usage of a single laser ray necessary in prior work. The proposed concept exploits this weakness to resolve severe ambiguities. Additionally, it should be noted that a real three-dimensional treatment helps to make the problem even easier, since the epipolar geometry additionally helps to filter out ambiguities since all ambiguities outside the epipolar plane can be rejected right away.

During the above explanations of the proposed methods, mostly only purely diffuse or purely specular surfaces have been considered. However, as widely known in computer vision and 3D metrology, most surface types are actually not purely diffuse or purely specular. Such surfaces like brushed metal, shiny plastic, or polished wood make very challenging cases for most optical 3D sensors. However, this is not the case for the proposed system. Shiny surfaces still have a small diffuse component that can have sufficient signal strength to be picked up by the event camera. On the other hand, a focused beam that undergoes a directed reflection at a shiny surface will be broadened or diffused out to a certain extent. The diameter of such a broadened beam that hits another surface is substantially larger than the diameter of the initial laser dot. Hence, this case can be easily filtered out by applying standard image processing algorithms to the event stream.

In summary, this means that, due to the special properties of the proposed system, all shiny surfaces can be treated and processed as diffuse surfaces in good approximation. This condition holds until the surface becomes nearly perfectly specular and will be separated from the diffuse parts by the proposed algorithm.

An example of use of the proposed system can include raster scanning a whole scene of interest with a laser projector, while simultaneously observing the scene with two event (or regular) cameras. An estimated scanning time is between 15 milliseconds (ms) and 30 ms, although the scanning time can be shorter or longer depending on the hardware used. Based on the raster scanning, diffuse and specular components are separated out (i.e., distinguished from one another) using the above-discussed procedure. The 3D coordinates of the diffuse scene parts are evaluated via active triangulation between projector and the two cameras. All of the diffuse scene parts (structured by the projector) are used as a screen to evaluate all specular scene parts via deflectometry. In some embodiments, the deflectometry evaluation is performed for each camera to further increase angular coverage and to introduce data redundancy for higher precision. These operations are repeated to capture a motion-robust 3D video (or 3D images). Depending on the scene, the system can also be moved around and used to register captured 3D models to scan very large scenes or to perform 360 degree scans of specular and/or diffuse objects. The system can be moved by hand, or alternatively the system can be mounted to a rotatable base that moves manually or automatically.

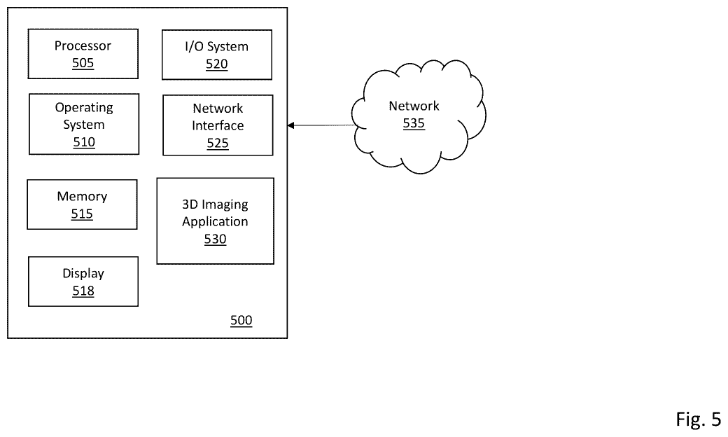

In an illustrative embodiment, any of the operations described herein can be performed by a computing system. The computing system can be incorporated into the laser projector or one of the cameras. The computing system can alternatively be a standalone computing system that controls and interacts with the various components of the system described herein. As an example, FIG. 5 depicts a computing system 500 for performing 3D imaging in accordance with an illustrative embodiment. In one embodiment, the computing system 500 can be separate from the 3D imaging system, but in communication therewith through a network 535 and/or through a direct wired connection.

The computing system 500 includes a processor 505, an operating system 510, a memory 515, a display 518, an input/output (I/O) system 520, a network interface 525, and a 3D imaging application 530. In alternative embodiments, the computing system 500 may include fewer, additional, and/or different components. The components of the computing system 500 communicate with one another via one or more buses or any other interconnect system. The computing system 500 can be any type of computing system (e.g., smartphone, tablet, laptop, desktop, etc.), including a dedicated standalone computing system that is designed to perform the 3D imaging. As noted above, the computing system 500 may also be incorporated into one or more of the projector, the first camera, and the second camera.

The processor 505 can be in electrical communication with and used to control any of the system components described herein. For example, the processor can be used to execute the 3D imaging application 530, control the hardware (e.g., projector and/or cameras), process image data, run algorithms, etc. The processor 505 can be any type of computer processor known in the art, and can include a plurality of processors and/or a plurality of processing cores. The processor 505 can include a controller, a microcontroller, an audio processor, a graphics processing unit, a hardware accelerator, a digital signal processor, etc. Additionally, the processor 505 may be implemented as a complex instruction set computer processor, a reduced instruction set computer processor, an x86 instruction set computer processor, etc. The processor 505 is used to run the operating system 510, which can be any type of operating system.

The operating system 510 is stored in the memory 515, which is also used to store programs, received measurements/data, network and communications data, peripheral component data, the 3D imaging application 530, and other operating instructions. The memory 515 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In some embodiments, at least a portion of the memory 515 can be in the cloud to provide cloud storage for the system. Similarly, in one embodiment, any of the computing components described herein (e.g., the processor 505, etc.) can be implemented in the cloud such that the system can be run and controlled through cloud computing.

The I/O system 520 is the framework which enables users and peripheral devices to interact with the computing system 500. The display 518 can include a touch screen in some embodiments, and the touch screen can be part of the I/O system 520 that allows a user to make selections, control sub-systems, view results, etc. The display 518 can be any type of display, including a monitor, projector, etc., and can be used to present user interface screens, measured readings, and other data to system user. The I/O system 520 can also include one or more speakers, one or more microphones, a keyboard, a mouse, one or more buttons or other controls, etc. that allow the user to interact with and control the computing system 500. The I/O system 520 also includes circuitry and a bus structure to interface with peripheral computing devices such as the cameras, laser projector, power sources, universal service bus (USB) devices, data acquisition cards, peripheral component interconnect express (PCIe) devices, serial advanced technology attachment (SATA) devices, high definition multimedia interface (HDMI) devices, proprietary connection devices, etc.

The network interface 525 includes transceiver circuitry (e.g., a transmitter and a receiver) that allows the computing system 500 to transmit and receive data to/from other devices such as remote computing systems, servers, websites, cameras, etc. The network interface 525 enables communication through the network 535, which can be one or more communication networks. The network 535 can include a cable network, a fiber network, a cellular network, a wi-fi network, a landline telephone network, a microwave network, a satellite network, etc. The network interface 525 also includes circuitry to allow device-to-device communication such as Bluetooth® communication.

The 3D imaging application 530 can include software and algorithms in the form of computer-readable instructions which, upon execution by the processor 505, performs any of the various operations described herein such as controlling a laser projector to perform a raster scan, controlling two cameras to monitor and analyze the scene during the raster scan, separating diffuse and specular components of the scan, evaluating the 3D coordinates of the diffuse scene parts via active triangulation between the laser projector and the cameras, using diffuse scene portions as a screen to evaluate specular scene portions via deflectometry, forming a 3D image or video, moving the system to capture additional portions of the scene, etc. The 3D imaging application 530 can utilize the processor 505 and/or the memory 515 and/or the display 518 as discussed above. In an alternative implementation, the 3D imaging application 530 can be remote or independent from the computing device 500, but in communication therewith.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more. ”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A three-dimensional (3D) imaging system comprising:
a projector configured to illuminate a scene;
a first camera configured to capture first data from the scene during illumination by the projector;
a second camera configured to capture second data from the scene during the illumination by the projector; and
a processor in communication with the first camera and the second camera, wherein the processor processes the first data and the second data to generate a 3D image or a 3D video.

2. The system of claim 1, wherein the projector comprises a laser dot scanner that is configured to scan the scene with a single laser dot.

3. The system of claim 2, wherein the first camera comprises a first event camera and the second camera comprises a second event camera, and wherein the processor is configured to identify a correspondence for each event-timestamp generated by the second event camera by comparing a position of the single laser dot on the scene with a pixel position of an event on the second event camera.

4. The system of claim 3, wherein the processor is further configured to calculate surface normals of the scene by tracing rays from the position of the single laser dot back to a camera chip of the second event camera.

5. The system of claim 1, wherein the processor does not have prior information regarding a geometry or a reflectance of the scene.

6. The system of claim 1, wherein the first camera captures a portion of an environment in which the scene is located, and wherein the portion of the environment is used as a screen to perform deflectometry.

7. The system of claim 6, wherein the processor uses the projector and the first camera to form a deflectometry sub-sensor.

8. The system of claim 6, wherein the processor uses the projector and the second camera to form a triangulation sub-sensor.

9. The system of claim 1, wherein the processor is configured to separate specular components and diffuse components of the scene based on one or more of the first data and the second data.

10. The system of claim 9, wherein the processor is configured to use the diffuse components of the scene as a screen to perform deflectometry on the scene.

11. The system of claim 1, wherein the first camera comprises a first event camera, and wherein the first event camera is configured to produce a timestamp of brightness changes at each pixel being imaged in the scene.

12. A method of three-dimensional (3D) imaging, the method comprising:
illuminating, by a projector, a scene that is to be imaged;
capturing, by a first camera, first data from the scene during illumination by the projector;
capturing, by a second camera, second data from the scene during the illumination by the projector; and
processing, by a processor in communication with the first camera and the second camera, the first data and the second data to generate a 3D image or a 3D video.

13. The method of claim 12, wherein the projector comprises a laser dot scanner, and wherein the illuminating comprises scanning the scene with a single laser dot.

14. The method of claim 13, wherein the first camera comprises a first event camera and the second camera comprises a second event camera, and further comprising identifying, by the processor, a correspondence for each event-timestamp generated by the second event camera by comparing a position of the single laser dot on the scene with a pixel position of an event on the second event camera.

15. The method of claim 14, further comprising calculating, by the processor, surface normals of the scene by tracing rays from the position of the single laser dot back to a camera chip of the second event camera.

16. The method of claim 12, further comprising capturing, by the first camera, a portion of an environment in which the scene is located, and using the portion of the environment as a screen to perform deflectometry.

17. The method of claim 12, further comprising forming, by the processor, the projector and the first camera into a deflectometry sub-sensor.

18. The method of claim 12, further comprising forming, by the processor, the projector and the second camera into a triangulation sub-sensor.

19. The method of claim 12, further comprising separating, by the processor, specular components and diffuse components of the scene based on one or more of the first data and the second data.

20. The method of claim 19, further comprising using, by the processor, the diffuse components of the scene as a screen to perform deflectometry on the scene.
